(19) United States
(12) Patent Application Publication
(10) Pub. No.: US 2010/0078414 A1
(43) Pub. Date: Apr. 1, 2010

(54) LASER ASSISTED DRILLING

(75) Inventors: Kent Perry, Schaumburg, IL (US); Iraj Salehi, Naperville, IL (US); Hamid A. Abbasi, Naperville, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 12/239,876

(22) Filed: Sep. 29, 2008

(51) Int. Cl. B23K 26/14; E21B 7/15

(52) U.S. Cl. 219/121.67; 175/11

(57) ABSTRACT

An apparatus for drilling underground having at least one optical fiber for transmitting light energy from a laser energy source disposed above ground to an underground drilling location and a mechanical drill bit having at least one cutting surface and forming at least one light transmission channel aligned to transmit light from the at least one optical fiber through the mechanical drill bit by way of the at least one light transmission channel.

### BACKGROUND OF THE INVENTION

1. Field of the Invention

This invention relates to underground drilling methods and apparatuses. In one aspect, this invention relates to non-vertical drilling methods and apparatuses for drilling non-vertical boreholes. In one aspect, this invention relates to the use of lasers as a means for augmenting the mechanical drilling process. In another aspect, this invention relates to the use of lasers as a means for augmenting the functionality of a mechanical drill bit used in drilling underground. In yet another aspect, this invention relates to the use of lasers as a means for facilitating the use of coiled tubing for drilling underground. In yet another aspect, this invention relates to use of laser as a means for cleaning the walls of drilled wells and removing formation damage from drilling fluid.

2. Description of Related Art

Conventional underground drilling is typically carried out using a rotary drill bit attached to a drill string. During the drilling operation, a drilling fluid is injected into the borehole for removal of debris generated by the drilling process. The drill bit is typically constructed from alloy steel and comprises pieces of carbide or diamond on the surface to break up the material being drilled. The two most common types of drill bits are fixed cutter and roller cone bits. The drill bit is attached to a drill string which consists of one or more sections of steel pipe connected together and rotated from above ground. Alternatively, the drill bit may be attached to a continuous steel pipe, known as coiled tubing, fed from a reel. In the case of coiled tubing, the drill bit is rotated by a downhole motor that is commonly hydraulically driven.

Coiled tubing is substantially more flexible than the connected pipe sections of a drill string. Depending upon the underground reservoir characteristics, holes may be drilled vertically, sideways, vertically then sideways, or vertically and then horizontally. It is not uncommon to make multiple side tracks from a single horizontal borehole into the underground formation to increase recovery. In most applications, particularly when drilling in harder materials, it is necessary to apply a certain amount of force on the drill bit to achieve the desired drilling speed. In vertical boreholes, when using a substantially rigid drill string, the force on the drill bit is controlled by a combination of the weight of the drill string above the bit and additional push or pull force applied to the drill string above ground. However, this method of force becomes less effective when drilling non-vertically, i.e. curved holes, side tracking or horizontal drilling, and even less effective when using a more flexible drill string such as coiled tubing, most notably when drilling in very hard materials such as granite. Methods have been developed to improve the drilling speed in these applications. The most common of these is the use of a tractor, which anchors to the surface of the drilled hole upstream of the bit while the downstream drill string is powered forward using electrical or hydraulic force. Although effective in many applications, the tractor systems are very expensive and have difficulties maneuvering through softer formations where the surface breaks down and is not able to provide the requisite anchoring. In addition, conventional drilling systems require a greater number of trips down the borehole as well as tools to stimulate the well after it has been drilled, clean the well surface, and measure formation properties.

The use of lasers for the purpose of producing boreholes to enable the extraction of liquid and gaseous fuels from underground formations is well-known in the art. U.S. Pat. No. 4,066,138 to Salisbury et al. teaches an earth boring apparatus mounted above ground that directs an annulus of high powered laser energy downwardly for boring a cylindrical hole by fusing successive annular regions of the stratum to be penetrated at a power level that shatters and self-ejects successive cores from the hole.

U.S. Pat. No. 4,282,940 to Salisbury et al. teaches an apparatus for perforating oil and gas wells. Using this method, a high-powered coherent light beam is axially directed along the borehole to a predetermined depth and deflected along a beam axis. The beam is focused to concentrate at each of a plurality of spaced focal points along the deflected beam. This, in turn, is said to provide a significant increase in the distance that calculated oil or gas bearing formations can be perforated, thereby increasing the yield by more conventional means.

The use of lasers for drilling is also taught by U.S. Pat. No. 4,113,036 to Stout in which underground boreholes are drilled through a formation from a plurality of vertical boreholes by use of laser beams to form a subsurface, three-dimensional bore passage pattern for in situ preparation of fossil fuel deposits to be recovered and a laser beam is projected vertically through an angularly adjusted tubular housing inserted into each borehole from which a reflected drilling beam is laterally directed by an angularly adjusted reflector to form a bore passage; U.S. Pat. No. 3,871,485 to Keenan, Jr. in which a laser beam generator positioned in a wellhole is electrically connected to an inhole voltage generator actuated by drilling mud or other liquid passing through a laser beam housing connected to the drill string and a reflecting crystal for the laser beam is positioned within the laser beam housing to reflect the beam in an elliptical pattern across the formation to be penetrated; U.S. Pat. No. 4,090,572 to Welch in which a laser beam for drilling gas, oil or geothermal wells in geological formations and for “fracing” the pay zones of such wells to increase recovery is projected into a borehole along a beam guide so as to make available laser energy adequate to melt or vaporize the formation under downhole conditions; and U.S. Pat. No. 5,107,936 to Foppe in which a gap defining the outer profile of a borehole is melted down and the drill core surrounded by this gap is extracted at intervals through the melting zone.

### SUMMARY OF THE INVENTION

It is one object of this invention to provide an apparatus for facilitating the use of coiled tubing in the underground drilling of boreholes.

It is one object of this invention to facilitate the underground drilling of non-vertical boreholes.

It is another object of this invention to provide a method and apparatus for borehole cleaning and stimulation.

These and other objects of this invention are addressed by an apparatus for drilling underground comprising at least one optical fiber for transmitting light energy from a laser energy source to an underground drilling location and a mechanical drill bit having at least one cutting surface and forming at least one light transmission channel aligned to transmit light from the at least one optical fiber through the mechanical drill bit by way of the at least one light transmission channel. This invention can increase the speed and/or efficiency of drilling systems for drilling holes in substances such as concrete, granite, limestone, sandstone, and other rock materials; it can be used for a wide range of drilling operations in substances such as concrete, cement, rock, limestone, marble, quartz, etc.; and it is especially suitable for drilling horizontal boreholes in the ground for producing and recovering oil, gas, water, and geothermal energy. This invention may also be used for drilling smaller holes for logging, for side tracking through existing holes or with reaming bits. It may be used to drill boreholes of a variety of sizes but is especially suitable for drilling holes in the range of about 0.5 inches to about 20 inches in diameter.

In operation, the laser energy is used for spalling or for weakening of the structure of the material to be drilled by softening the material ahead of mechanical drilling. Hard materials such as granite should be significantly easier to drill using a mechanical drill bit after having been presoftened. Drilling fluid, also referred to as drilling mud, may be circulated through and around the drilling tool to cool the system as well as remove the debris. In accordance with one embodiment, a static, dynamic, mechanical, electro mechanical, or other type of separator, such as a cyclone, may be employed to remove contaminants from a portion of the drilling mud, which, in turn, may be used to clear a path ahead of the laser so as to maximize laser energy impingement on the material being drilled. In accordance with one embodiment, a fluid containing at least one of water, air, nitrogen, CO₂ or another fluid that is substantially transparent to laser energy may be injected into the laser path to at least partially clear the path ahead of the laser. In yet a further embodiment, debris generated by the laser energy may be analyzed and the results fed into instrumentation to determine the properties of the formation for drilling control to optimize drilling efficiency and maximize well production efficiency. In yet another embodiment, the laser energy may be used for cleaning and stimulation of the borehole.

### BRIEF DESCRIPTION OF THE DRAWINGS

These and other objects and features of this invention will be better understood from the following detailed description taken in conjunction with the drawings wherein:

FIG. 1 is a schematic lateral view of a drill head end of drilling apparatus in accordance with one embodiment of this invention;

FIG. 2 is a schematic lateral view of a drilling apparatus in accordance with one embodiment of this invention;

FIG. 3 is a schematic lateral view of a drilling apparatus in accordance with one embodiment of this invention in which a fluid is used to cool the laser drill bit assembly and remove cuttings;

FIG. 4 is a lateral schematic view of a drilling system in accordance with one embodiment of this invention in which a portion of the optical fiber through which the laser energy is transmitted is disposed within the interior of the mechanical drill bit;

FIG. 5 is a lateral schematic view of a drilling system in accordance with one embodiment of this invention utilizing an optical coupling for coupling the optical fiber with the mechanical drill bit;

FIG. 6 is a lateral schematic view of a drilling system in accordance with another embodiment of this invention utilizing an optical coupling for coupling the optical fiber with the mechanical drill bit;

FIG. 7 is a lateral schematic view of a drilling system in accordance with one embodiment of this invention utilizing an optical coupling for coupling the optical fiber with a mechanical drill bit having a plurality of laser energy outlet ports;

FIG. 8 is a schematic diagram of an optical coupling for use in accordance with one embodiment of this invention;

FIG. 9 is a schematic diagram of another optical coupling for use in accordance with one embodiment of this invention;

FIG. 10 is a transverse sectional view of an optical fiber disposed within an armored cable in accordance with one embodiment of this invention; and

FIG. 11 is a schematic diagram of a system for formation characterization utilizing a drilling apparatus in accordance with one embodiment of this invention.

### DETAILED DESCRIPTION OF THE PRESENTLY PREFERRED EMBODIMENTS

The invention disclosed herein is a laser assisted drilling system for underground drilling, which includes a laser assisted mechanical drill bit and optical fibers for the transmission of laser energy from a laser source disposed above ground or within the drill string to the drill bit. The advantages of this invention compared with conventional technologies include an increase in drilling speed due to the use of laser energy to spall ahead of the mechanical drill bit the material ahead of the mechanical drill bit being drilled prior to utilization of the mechanical drill bit; the ability to use the laser energy on demand to selectively soften the material only when needed; the ability to use smaller diameter and thinner wall drill strings due to the reduced force on the drill bit, more control over the direction of the drilling, and less tendency of the drill string to buckle, especially with respect to flexible drill strings such as coiled tubing; the ability to provide additional services downhole, such as measurement while drilling (MWD), logging while drilling (LWD), seismic logging, steering of the drill bit, and sweet spot detection due to the available bandwidth for data transmission provided by the optical fiber; and the ability to use the information gathered during the drilling operation for directing the laser assisted drill bit to clean and stimulate the well as the drill bit is removed. In addition, the use of laser energy for well stimulation and cleaning reduces the need for conventionally employed chemicals for these operations, thereby reducing the environmental impact of the drilling and completion operation.

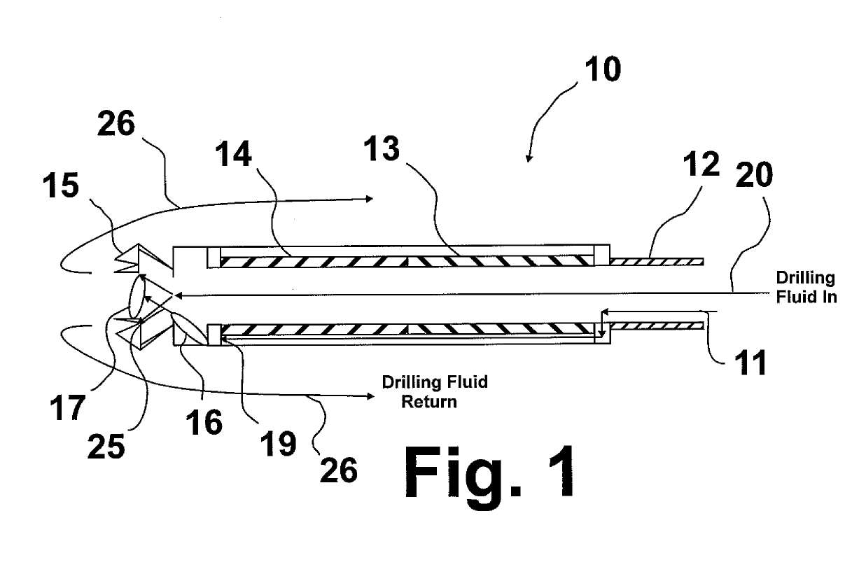

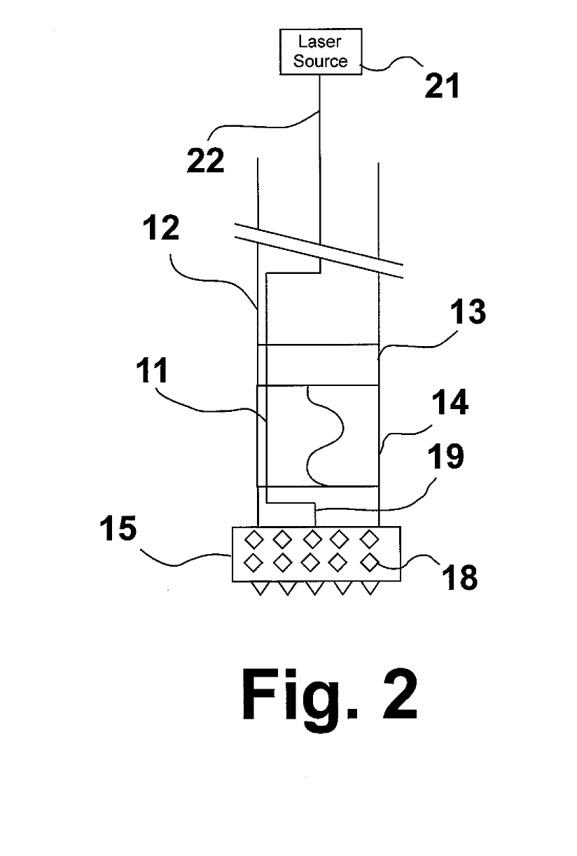

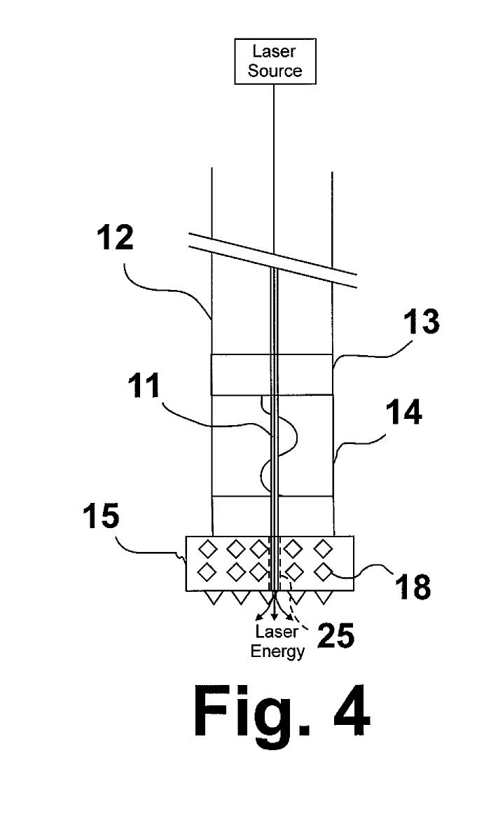

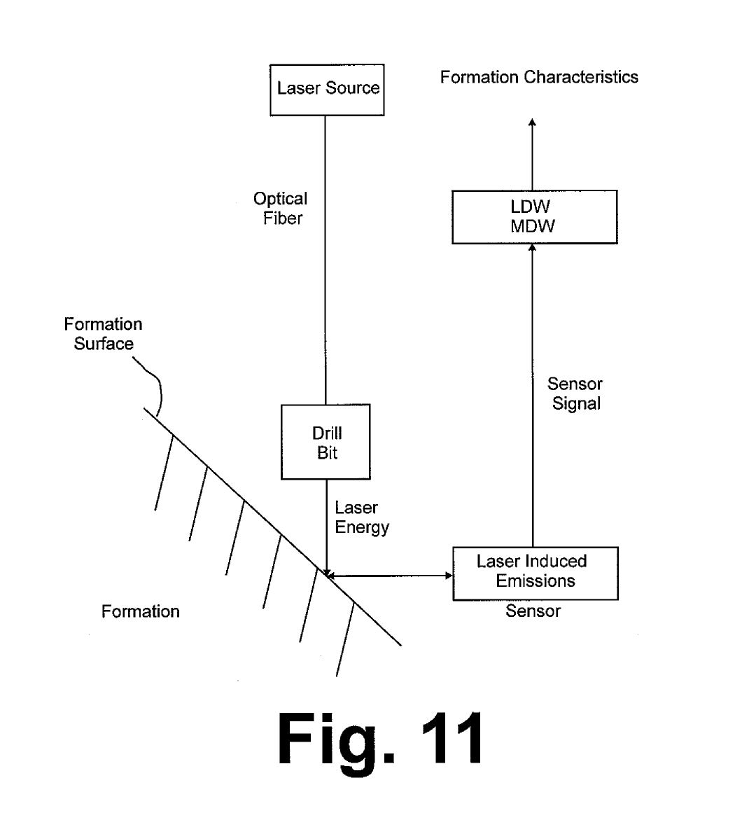

The apparatus of this invention for underground drilling, FIGS. 1-7, comprises a laser assisted drill bit end 10 comprising at least one optical fiber 11 having a light inlet end 22 connected with a laser energy source 21 and having a light output end 19, a mechanical drill bit 15 having at least one cutting surface 18 and forming at least one light transmission channel 25 aligned to transmit light from the at least one optical fiber 11 through the mechanical drill bit 15 by way of the at least one light transmission channel 25. Mechanical drill bit 15 is connected with the drilling end of drill string 12, which, in accordance with one particularly preferred embodiment of this invention is formed by coiled tubing. In accordance with one embodiment of this invention, the at least one optical fiber 11 is disposed within an armored cable 23 as shown in FIG. 10. In accordance with one embodiment of this invention, the drill head end further comprises an optical assembly 16 through which light from light output end 19 of optical fiber 11 is transmitted through the at least one light transmission channel 25 to a lens 17 at a surface of or within mechanical drill bit 15.

As previously indicated, during the drilling operation, a drilling fluid 20, i.e. drilling mud, is provided to the drill bit 15 for cooling of the drill bit and removal of debris from around the drill bit. The drilling mud is conveyed through a mud motor 14 disposed rearward of the mechanical drill bit through which the drilling mud is transmitted to the mechanical drill bit. After cooling of the drill bit, the drilling mud flows around the exterior of the drill string as indicated by arrows 26 up to the top of the borehole, taking with it debris from the area of drilling within the borehole.

Disposed rearward of mud motor 14 in accordance with one embodiment of this invention, is instrumentation package 13 for providing MWD and/or LWD services.

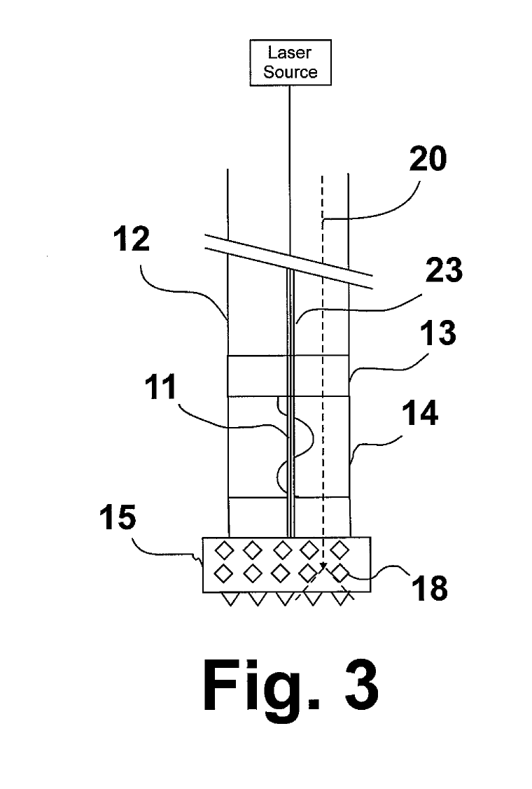

In accordance with one embodiment of this invention as shown in FIG. 1, optical fiber 11 is routed from the drill string into an annular space 27 disposed around the exterior of instrumentation package 13 and mud motor 14. In accordance with one preferred embodiment of this invention as shown, for example, in FIG. 3, optical fiber 11, disposed within armored cable 23, is routed through instrumentation package 13 and mud motor 14 to mechanical drill bit 15.

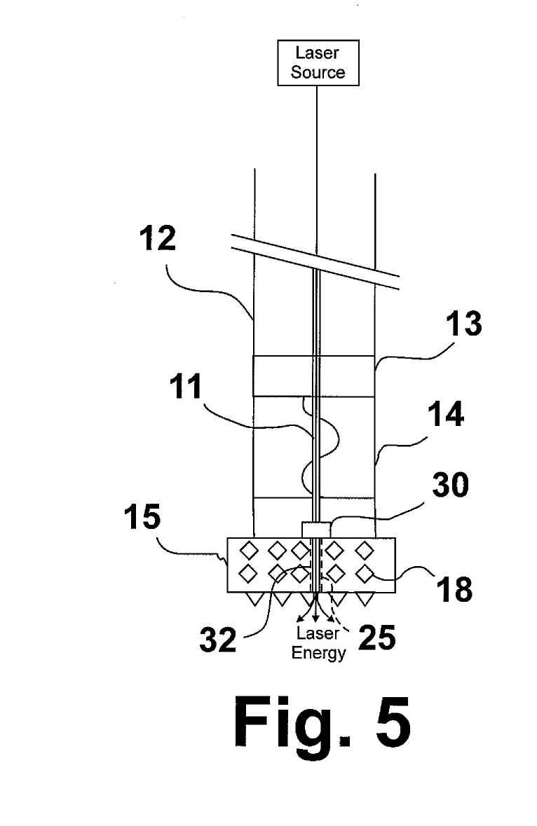

As previously indicated, mechanical drill bit 15 forms at least one light transmission channel 25 through which light from optical fiber 11 is transmitted to an area ahead of the mechanical drill bit during the drilling operation. In accordance with one embodiment, optical fiber 11 extends through light transmission channel 25 substantially to the leading surface of the mechanical drill bit and, as shown in FIG. 3, mechanical drill bit 15 rotates around the light output end of the optical fiber with the optical fiber being stationary. In accordance with another embodiment of this invention, as shown in FIG. 5, optical fiber 11 is in two separate segments, one of which is disposed in a stationary manner within mechanical drill bit 15. In this case, the segment of the optical fiber 32 within the mechanical drill bit rotates with the drill bit and an optical coupling 30 provides communication of light from the end of the optical fiber disposed within the drill string to the segment of the optical fiber disposed within the mechanical drill bit. Optical coupling 30 is connected with mechanical drill bit 15 in a manner which enables the mechanical drill bit and, thus, the segment of the optical fiber disposed therein to rotate, all the while maintaining the portion of the optical fiber within the drill string stationary. Transition means for transitioning between rotating and non-rotating elements are known in the art and, thus, will not be described herein. The primary requirement for such transition means is that it be able to withstand the conditions in existence downhole during the drilling operation.

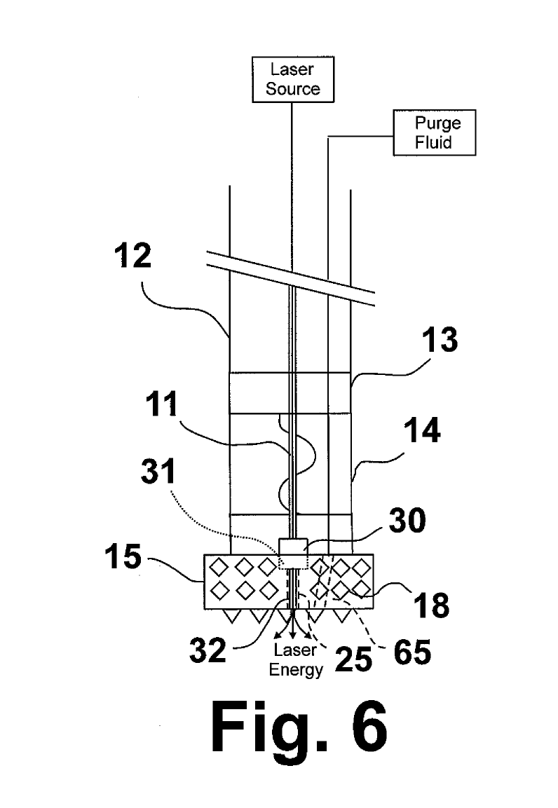

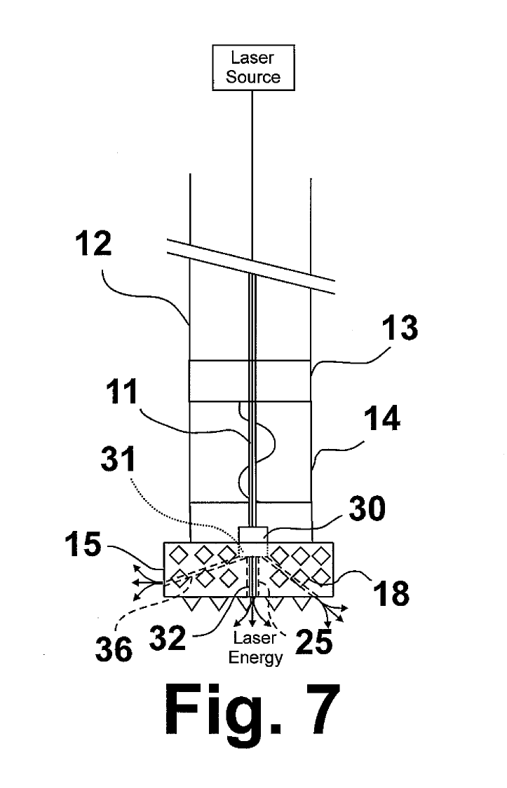

In accordance with one embodiment of this invention, mechanical drill bit 15 forms an optical cavity 31 aligned with optical coupling 30 as shown in FIG. 6. In accordance with one embodiment of this invention, the interior surface of the optical cavity is reflective. One benefit of optical cavity 31 as shown in FIG. 6 is that it enables the distribution of light from the portion of the optical fiber within the drill string to a plurality of light transmission channels 25, 36 formed by the mechanical drill bit as shown in FIG. 7. In accordance with one embodiment of this invention, an optical fiber segment is disposed in one or more of the light transmission channels. In accordance with one embodiment of this invention, the interior surfaces of the light transmission channels are light reflective, in which case disposition of an optical fiber segment therein may not be necessary.

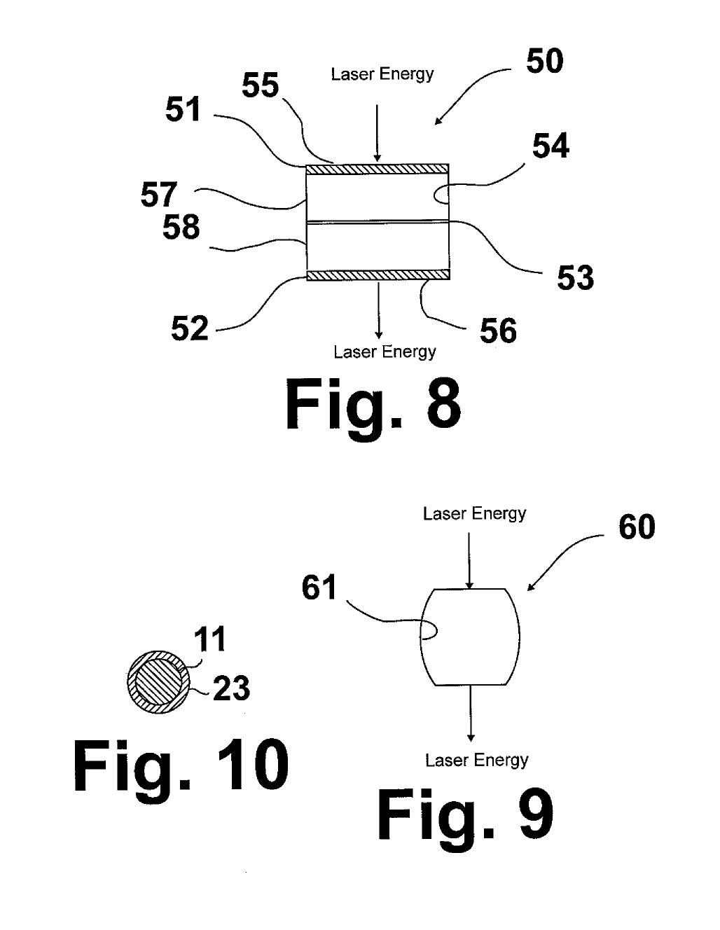

FIG. 8 shows a lateral cross-sectional view of an optical coupling having a laser energy inlet side 55 and an opposite laser energy outlet side 56 for use in coupling the at least one optical fiber within the drill string with the mechanical drill bit, in particular, the one or more light transmission channels of the mechanical drill bit, in accordance with one embodiment of this invention. The optical coupling is divided into two elements, a non-rotatable element 57 and a rotatable element 58 between which is a seal 53. As shown therein, in accordance with one embodiment of this invention, optical coupling 50 comprises a transmitting lens 51 on the laser energy inlet side of the optical coupling and a receiving lens 52 disposed opposite the transmitting lens on the laser energy outlet side of the coupling.

In accordance with one embodiment of this invention, shown in FIG. 9 is optical coupling 60 having concave, reflective side walls 61 between the laser energy inlet and outlet sides of the coupling. The reflective side walls help to direct the laser energy entering the coupling to the laser energy outlet side of the coupling.

It will be appreciated that during operation of the laser assisted drill bit, debris from the drilling operation may come between the laser energy outlet or outlets from the light transmission channels and the desired formation target, thereby inhibiting the transmission of laser energy to the formation target. In accordance with one embodiment of this invention, shown in FIG. 6, mechanical drill bit 15 forms at least one purge fluid transmission channel 65 having a purge fluid outlet directed in the direction of the laser energy output from the light transmission channels. During the drilling operation, a purging fluid is used to purge the area of debris present in the laser energy path. Any purging fluid which allows for 50% or more laser energy transmission of laser energy exiting the light transmission channels may be used. Such purging fluids include, but are not limited to air, water, or other gases. In accordance with one embodiment of this invention, a static, dynamic, mechanical electro mechanical or other type of separator, such as a cyclone is used, either upstream or downstream of the mud motor to remove contaminants from a portion of the drilling mud. The cleaner mud may then be injected at the drill bit into the path of the laser to minimize absorption of the laser energy into the mud in the path of the laser and maximize its impingement on the material being drilled.

As previously indicated, in addition to transmitting and controlling the laser energy and its direction, the bandwidth available in the optical fibers may also be used to perform additional services such as MWD, LWD, seismic logging and sweet spot detection. Thus, LDW, MDW and other information gathered during the drilling operation may be used to direct the laser assisted drill bit to clean and stimulate the well as the drill bit is removed from the borehole. The use of laser energy for well stimulation and cleaning reduces the need for conventionally used explosives and chemicals for these operations, thereby reducing the environmental impact of the drilling and completion operation. In addition, the laser energy may be used to generate emissions from formations to provide formation property data. Such an application is shown in FIG. 11.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

We claim:

1. An apparatus for drilling underground comprising:
at least one optical fiber having a light inlet end connected with a laser energy source and having a light output end; and
a mechanical drill bit having at least one cutting surface and forming at least one light transmission channel aligned to transmit light from said at least one optical fiber through said mechanical drill bit by way of said at least one light transmission channel.

2. The apparatus of claim 1, wherein said at least one optical fiber is disposed within an armored cable.

3. The apparatus of claim 2, wherein said armored cable is disposed within a coiled tubing.

4. The apparatus of claim 1, wherein said at least one optical fiber extends through a complete length of said at least one light transmission channel.

5. The apparatus of claim 1 further comprising cooling means for cooling said mechanical drill bit.

6. The apparatus of claim 1 further comprising service means for providing while drilling at least one service selected from the group consisting of MWD, LWD, seismic logging, drill bit steering, sweet spot detection, cleaning, and stimulation, said service means disposed proximate and to a rear of said mechanical drill bit.

7. The apparatus of claim 1 further comprising laser path means for providing a clear line of sight for laser energy emitted by said mechanical drill bit.

8. The apparatus of claim 1, wherein an interior surface of said mechanical drill bit is light transmissive.

9. The apparatus of claim 1, wherein said mechanical drill bit forms a plurality of light exit ports in light communication with said at least one light transmission channel.

10. The apparatus of claim 9, wherein a rear portion of said mechanical drill bit forms an optical cavity in fluid communication with said at least one light transmission channel.

11. A method for underground drilling comprising the steps of:
spalling or softening a material to be drilled using laser energy transmitted through a mechanical drill bit, forming a reduced-strength material; and
mechanically drilling said reduced-strength material using said mechanical drill bit, forming cuttings and a borehole.

12. The method of claim 11, wherein said borehole is disposed at an angle with respect to vertical.

13. The method of claim 12, wherein said mechanical drill bit is connected with a leading end of a coiled tubing drill string.

14. The method of claim 11, wherein said cuttings are removed from said borehole by a drilling fluid introduced into said borehole.

15. The method of claim 11, wherein said laser energy is transmitted to said mechanical drill bit by at least one optical fiber disposed within a drill string and connected with a laser energy source.

16. The method of claim 15 further comprising transmitting data from at least one of MWD, LWD, and seismic sensors located within and upstream of said mechanical drill bit through said at least one optical fiber.

17. The method of claim 11, wherein said drilling and at least one of logging, sweet spot identification, steering, borehole cleanup and stimulation is carried out during a single trip of said mechanical drill bit into and out of said borehole.

18. The method of claim 11, wherein at least one purge fluid is injected into said borehole ahead of said mechanical drill bit, maintaining a substantially clear path for said laser energy.

19. The method of claim 18, wherein said at least one purge fluid is selected from the group consisting of water, air, nitrogen, carbon dioxide, and mixtures thereof.

20. The method of claim 11 further comprising measuring formation properties during insertion and removal of said mechanical drill bit.

21. The method of claim 14, wherein at least a portion of said drilling fluid is cleaned downhole for use as a purge fluid.
